(19) United States
(12) Patent Application Publication
(10) Pub. No.: US 2025/0074841 A1
(43) Pub. Date: Mar. 6, 2025

(54) SYSTEMS AND METHODS FOR SEPARATING A MIXTURE OF COMPRESSED-GAS SOLVENTS

(71) Applicant: Bizzybee LLC, Tacoma, WA (US)

(72) Inventor: Boris David Kogon, Tacoma, WA (US)

(21) Appl. No.: 18/952,846

(22) Filed: Nov. 19, 2024

Related U.S. Application Data
(63) Continuation of application No. 18/133,495, filed on Apr. 11, 2023, now Pat. No. 12,145,896.
(60) Provisional application No. 63/329,815, filed on Apr. 11, 2022.

(51) Int. Cl. C07B 63/00; B01D 53/00

(52) U.S. Cl. CPC C07B 63/00; B01D 53/002; F25J 2205/02; F25J 2290/12

(57) ABSTRACT

Techniques and systems for separating components of a mixture of compressed gases each having different boiling points are described. One example system includes multiple recovery stages that each recover one of the gases by condensing it into liquid form. The recovery stages are chained together, such that each stage recovers a gas having a boiling point that is higher than those of the gases to be recovered in downstream stages. Each stage typically includes a warming element that is fluidly coupled to a condenser element that provides a surface cooled to a temperature low enough to condense one of the gases, but high enough such that the remaining gases remain in gaseous form. The system may include an initial evaporator stage that heats a liquid solution of phytochemical extracts and multiple solvents, thereby recovering the extracts and producing the mixture of gaseous solvents.

### CROSS-REFERENCE TO RELATED APPLICATIONS

This application is a continuation of U.S. patent application Ser. No. 18/133,495, filed Apr. 11, 2023; which claims the benefit of priority from U.S. Provisional Patent Application No. 63/329,815, filed Apr. 11, 2022, the entire contents of which are incorporated herein by reference in their entirety.

### TECHNICAL FIELD

The present disclosure relates to systems and methods for separating components of a mixture of substances, and more particularly, a mixture of compressed gases having different boiling points.

### BRIEF DESCRIPTION OF THE DRAWINGS

FIGS. 1A and 1B are block diagrams that illustrate the functional components of separation systems according to example embodiments.

FIG. 2 is a block diagram that illustrates components used in one implementation of the described separation system.

FIG. 3 is a diagram that illustrates an example separation system configured to separate a solution comprising a solute of one or more cannabis extracts and a solvent mixture of propane and n-butane.

FIGS. 4A-4D are views of a heat exchanger employed in an example embodiment.

FIGS. 5A and 5B are phase diagrams for butane and propane, respectively.

### DETAILED DESCRIPTION

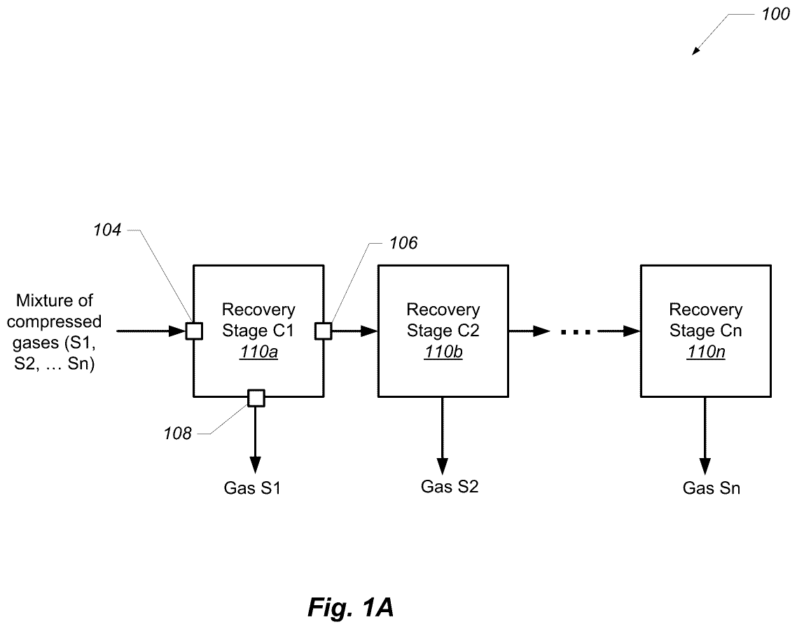

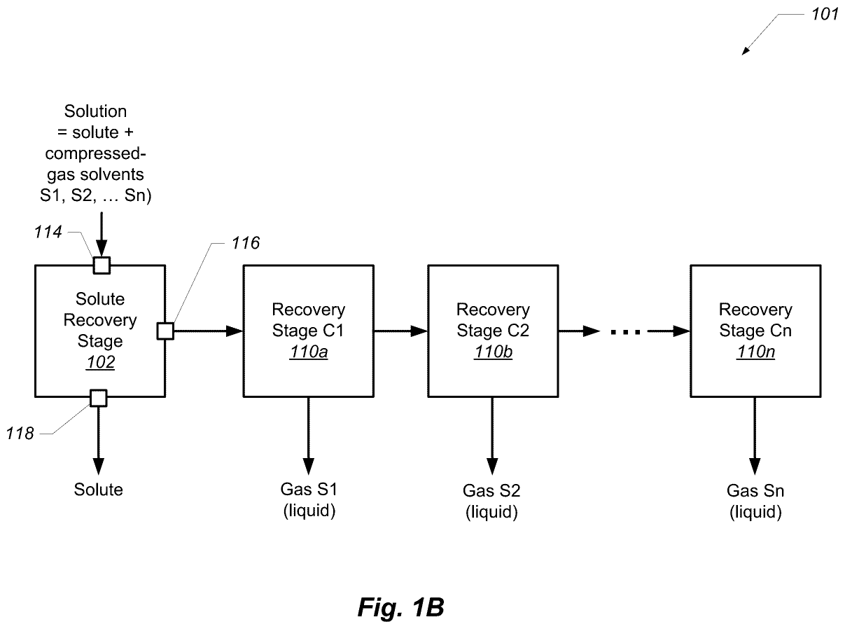

FIG. 1A is a functional block diagram of a separation system 100 according to one embodiment. The system 100 is configured to separate a mixture of compressed gases each having a different boiling point. The system 100 includes one or more recovery stages 110a-110n. The recovery stages 110a-110n are for ease of reference also respectively labeled C1, C2, . . . Cn. Each stage in the system includes an input port, output port, and recovery port. For example, recovery stage 110a includes an input port 104, output port 106, and recovery port 108. With the exception of the final stage Cn, each output port of a stage is fluidly coupled to the input port of subsequent (downstream) stage.

Initially, a mixture of compressed gases is introduced into recovery stage 111a via the input port 104. The mixture comprises multiple compressed gases S₁, S₂, . . . Sₙ. Each gas Sᵢ has a corresponding boiling point Tᵢ that is less than Tᵢ₋₁ and greater than Tᵢ₊₁. Put another way, the gases are for descriptive purposes denoted in decreasing order by boiling point, such that gas S₁ has the highest boiling point and gas Sₙ has the lowest boiling point.

The gases S₁ . . . Sₙ, pass through the recovery stages C1 . . . Cn, with each gas being recovered at a corresponding recovery stage. In this example, recovery stage C₁ receives the gases S₁ . . . Sₙ via its input port 104. Recovery stage C1 chills the received gases to a temperature that causes gas S₁ to condense into liquid form while allowing gases S₂ . . . Sₙ to remain in gaseous form. More formally, each recovery stage Cᵢ chills its received mixture of gases to a temperature T that is less than the boiling point Tᵢ of gas Sᵢ and greater than the boiling point Tᵢ₊₁ of gas Sᵢ₊₁. Liquid S₁ is recovered via the recovery port 108 of stage C1 while gases S₂ . . . Sₙ pass onwards to stage C2 in gaseous form.

Recovery stage C2 receives the gases S₂ . . . Sₙ from the output port 106 of stage C1. Recovery stage C2 chills the received gases at a temperature that causes gas S₂ to condense into liquid form while allowing gases S₃ . . . Sₙ to remain in gaseous form. Liquid S₂ is recovered via the recovery port of stage C2 while remaining gases S₃ . . . Sₙ pass onwards in gaseous form to stage C3 and thence onwards through the remainder of the system, where each gas Sᵢ is recovered at its corresponding recovery stage Cᵢ.

FIG. 1B is a functional block diagram of a separation system 101 according to another embodiment. The system 101 is configured to separate a mixture of compressed gases each having a different boiling point. In typical applications, the system 101 is configured to separate and recover the components of a solution that is initially introduced in liquid form. The system 101 includes a solute recovery stage 102 and one or more compressed-gas solvent recovery stages 110a-110n. The gas recovery stages 110a-110n are for ease of reference also respectively labeled C1, C2, . . . Cn. As in FIG. 1A, each stage in the system includes an input port, output port, and recovery port. For example, solute recovery stage 102 includes an input port 114, output port 116, and recovery port 118. With the exception of the final stage Cn, each output port of a stage is fluidly coupled to the input port of subsequent (downstream) stage.

Initially, a solution in liquid form is introduced into solute recovery stage 102 via the input port 114. The solution comprises a solute and one or more compressed-gas solvents S₁, S₂, . . . Sₙ in liquid form. Each gas Sᵢ has a corresponding boiling point Tᵢ that is less than Tᵢ₋₁ and greater than Tᵢ₊₁. Put another way, the gases are for descriptive purposes denoted in decreasing order by boiling point, such that gas S₁ has the highest boiling point and gas Sₙ has the lowest boiling point.

The solute recovery stage 102 heats the received solution. A sufficient amount of heat is added to boil the compressed-gas solvents while retaining the solute in liquid form. Stage 102 thus operates as an evaporator. More formally, the solution is heated to a temperature T, where T is less than the boiling point of the solute but greater than the boiling point of each of the compressed-gas solvents. The gases S₁ . . . Sₙ in gaseous form pass onwards to recovery stage C₁ via the output port 116, while the solute is recovered via the recovery port 118.

As described with respect to FIG. 1A, the gases S₁ . . . Sₙ, pass through the recovery stages C1 . . . Cn, each gas being recovered at a corresponding recovery stage. In this example, recovery stage C1 receives the gases S₁ . . . Sₙ from the solute recovery stage 102. Gas recovery stage C1 chills the received gases to a temperature that causes gas S₁ to condense into liquid form for recovery, while allowing gases S₂ . . . Sₙ to remain in gaseous form and pass onward to stage C2. Stage C2, in turn chills gases S₂ . . . Sₙ to a temperature that causes gas S₂ to condense into liquid form for recovery. Gases S₃ . . . Sₙ continue onwards down the line, each gas Sᵢ being recovered at a corresponding stage Ci.

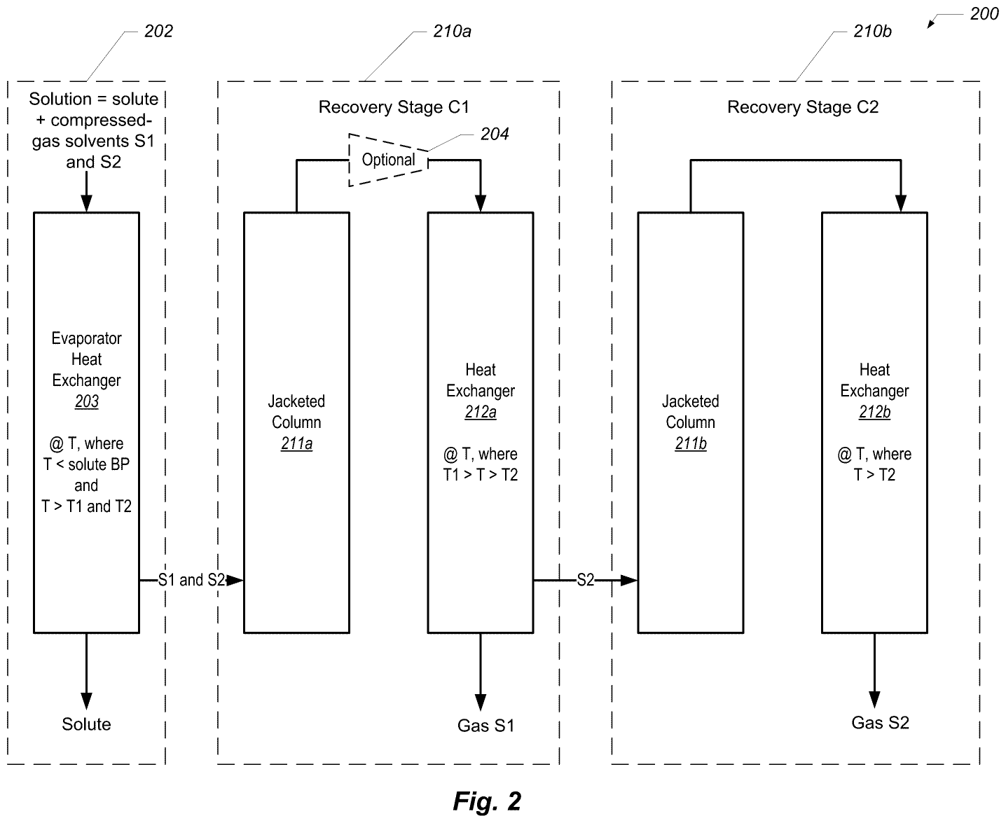

FIG. 2 is a block diagram that illustrates components used in one implementation of the described separation system. More specifically, FIG. 2 shows a separation system 200 that includes a solute recovery stage 202 and compressed-gas solvent recovery stages 210a and 210b (C1 and C2). A solution in liquid form comprising a solute, compressed-gas solvent S1 and compressed-gas solvent S2 introduced into the solute recovery stage 202. Gases S1 and S2 have corresponding boiling points of T1 and T2, where T1 is greater than T2.

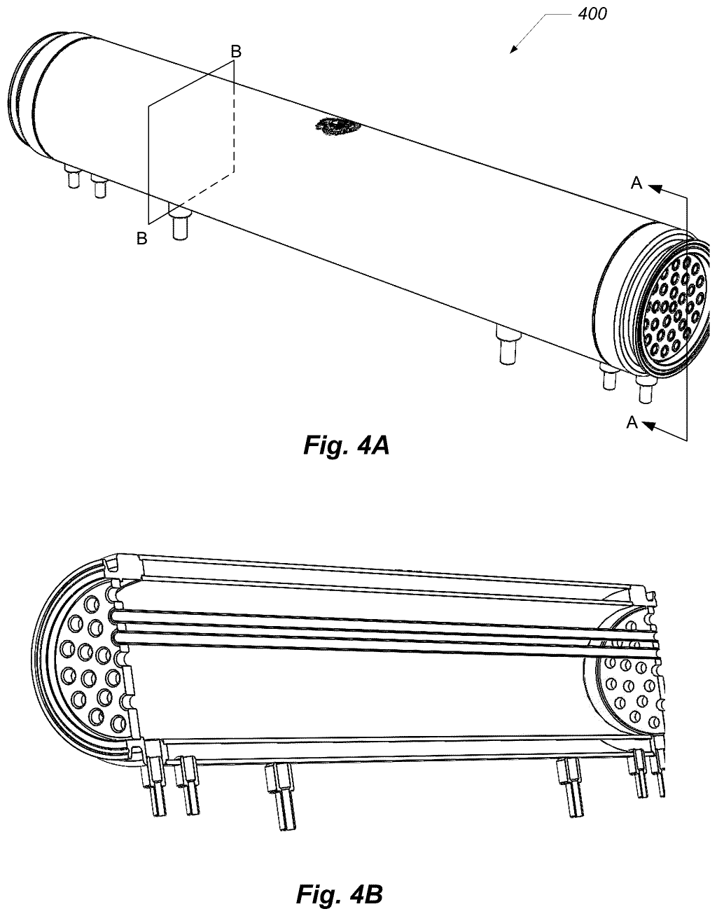

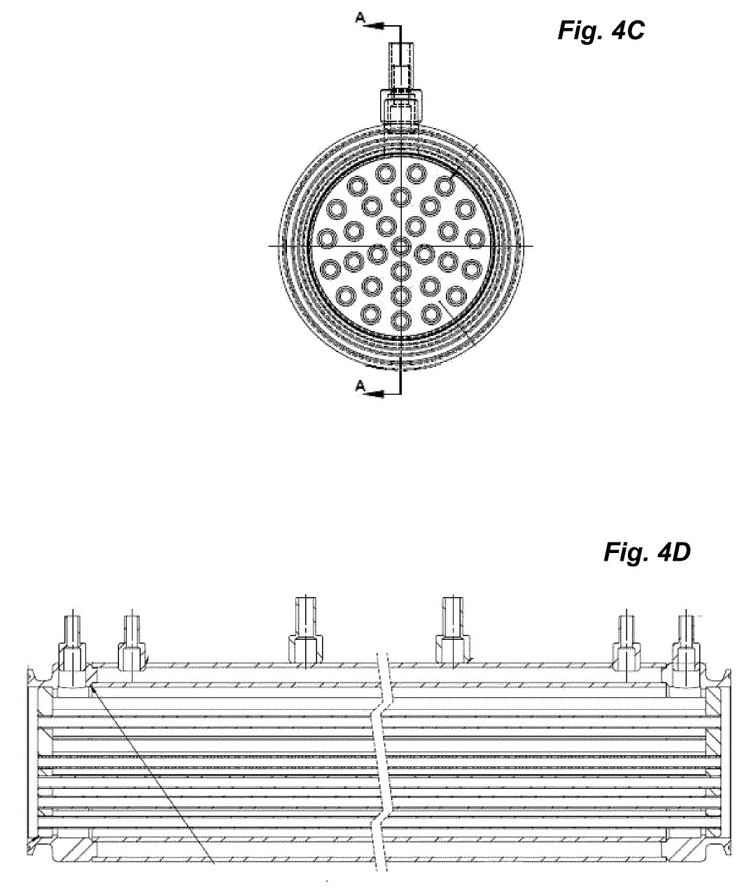

The solute recovery stage 202 includes a heat exchanger 203 that heats the solution to a temperature T, where T is less than the boiling point of the solute but greater than the boiling points of all the gases. The solute is recovered in liquid form while the gases pass in gaseous form to recovery stage C1. A heat exchanger is any device or system that can exchange heat between two fluids. Preferably, a falling film evaporator including a tube and shell heat exchanger is employed, although the use of other types of heat exchangers is contemplated, including tube in tube, plate and shell, finned tube, or the like. An example tube and shell heat exchanger is illustrated and described with reference to FIG. 4, below.

The recovery stage C1 includes a jacketed column 211a and a heat exchanger 212a. The jacketed column 211a heats the received mixture of gases S1 and S2 from the heat exchanger 203. Heating the mixture at a temperature that is above the boiling point of S1 reduces reflux in the system 200.

A jacketed column is a tubular column having an inner vessel surrounded by an outer vessel, which forms a jacket around the inner vessel. The inner vessel and jacket form non-connected spaces, which are independently accessed via separate input and output ports. Warm or cold liquid can be introduced into the jacket to heat or chill liquids or gases present in the inner vessel. In typical embodiments, the input to the jacket of column 211a receives fluid output from the jacket of the heat exchanger 203. The jacket of column 211a thus receives spent heating fluid from the heat exchanger 203. The jackets for downstream columns can be similarly provided with spent heating fluid from any one or more upstream jacketed columns or the initial heat exchanger 203. This technique advantageously reduces energy use as the heat present in spent heating fluid can be used to warm downstream components.

Jacketed columns suitable for use with the described techniques and system are described in detail in U.S. Pat. No. 10,315,130, issued Jun. 11, 2019, entitled “PHYTOCHEMICAL EXTRACTION SYSTEMS, METHODS, AND DEVICES,” the contents of which are incorporated by reference herein. Although jacketed columns are used in typical embodiments, other types of heat exchanging devices can be used.

The heated mixture of gases passes from the jacketed column 211a to the heat exchanger 212a, which chills the received mixture to temperature T, where T is less than the boiling point of gas S1 (T1) but greater than the boiling point of gas S2 (T2). Gas S1 condenses into liquid form and is recovered at a recovery port of stage C1. Gas S2 remains in gaseous form and passes to recovery stage C2.

The recovery stage C2 is configured similarly to stage C1. Stage C2 includes a jacketed column 211b and a heat exchanger 212b. The jacketed column 211b heats the gas S2 to prevent reflux as discussed above. The heated gas S2 passes to the heat exchanger 212b, which chills the received gas to temperature T, where T is less than the boiling point of gas S2. Gas S2 condenses into liquid form and is recovered at a recovery port of stage C2. If there are any remaining components of the mixture, these can be further processed downstream by using additional recovery stages, captured for later use, or alternatively vented to the environment.

The described system may also include an optional compressor 204 between or within one or more of the stages. A compressor advantageously raises the boiling points of the gases, which means the entire system can be run at higher temperatures, thus saving on refrigeration costs. The preferred placement of the compressor is within recovery stage C1, after the output of the jacketed column 211a and before the input of the heat exchanger 212a. In some embodiments, the compressor (or an additional compressor is placed within recovery stage C2.

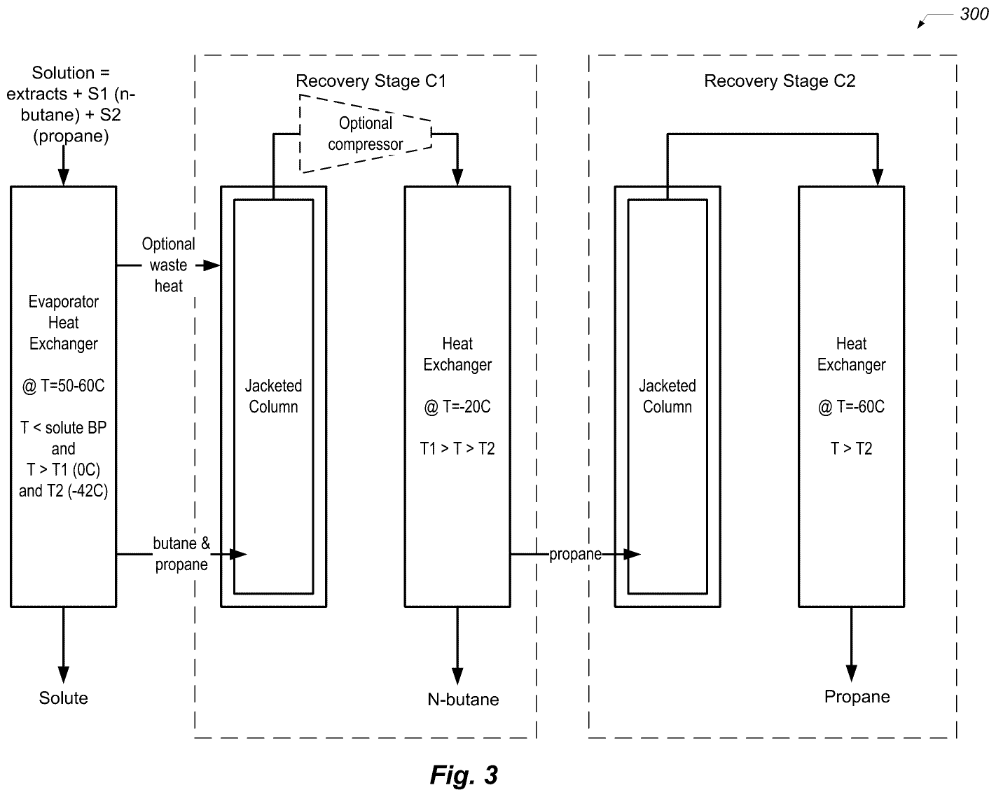

FIG. 3 is a diagram that illustrates an example separation system 300 configured to separate a solution comprising a solute of one or more cannabis extracts and a compressed-gas solvent mixture of propane and n-butane. Such an embodiment can be used to separate the components of a hydrocarbon-based phytochemical extraction process. For example, mixtures of n-butane, isobutane, and/or propane may be used to extract desirable compounds from cannabis. A typical extraction process washes the cannabis in a mixture of liquid n-butane and propane, resulting in a solution comprising the compressed-gas solvents as well as dissolved cannabis compounds (the solute). At 1 atmosphere, N-butane has a boiling point of about 0C; propane has a boiling point of about −42C; and isobutane has a boiling point of about −12C.

As shown in FIG. 3, given an extraction process that uses n-butane and propane, the system 300 may be used to separate the solute and the compressed-gas solvents used in the extraction process. The solution resulting from the extraction process is initially introduced into a tube and shell heat exchanger in the solute recovery stage. This heat exchanger serves as an evaporator. It runs hot enough to boil all the compressed-gas solvents in the mixture. The temperature of the heat exchanger is less than the boiling point of the solute but greater than the highest boiling point in the mixture. In a typical application where the mixture of compressed-gas solvents is n-butane and propane, the temperature is 40-50C. The compressed-gas solvents boil and pass into the first recovery stage (C1) while the solute is recovered from the heat exchanger.

The gases pass into a jacketed column of C1 that runs at a temperature above the boiling point of the n-butane, or above 0C. This jacketed column prevents reflux as discussed above. The mixture of gases passes from the jacketed column into a tube and shell heat exchanger that chills the mixture, running at or below the highest boiling point of the gases in the mixture. In general, the temperature of a heat exchanger in a recovery stage is 10-20C lower than the boiling point of the gas to be separated at a given stage, but always higher than the highest boiling point of the remaining gases in the mixture. In an application to separate n-butane (boiling point of about OC at 1 atm) and propane (boiling point of about −42C at 1 atm), the heat exchanger typically runs at about −20C. The heat exchanger causes the n-butane to condense so that it can be recovered in liquid form. The remaining gas (propane) passes to the second recovery stage C2.

As discussed above, stage C2 is configured similarly to stage C1. Gas passes into a jacketed column, which heats the gas to prevent reflux. The gas then passes into a heat exchanger that chills and condenses the gas for recovery. In a typical application to separate n-butane and propane (boiling point of about −42C at 1 atm), the heat exchanger runs at about −60C.

Of course, further stages can be added, one stage per gas being separated, so long as the boiling points of the gases are sufficiently distinct. The entire system is iso-baric, meaning that is runs at approximately the same pressure throughout. More particularly, the pressure within the system is a function of the vapor pressure of the compressed gas having the lowest boiling point at the temperature at which that gas is being chilled. For example, for propane at −50C, this would be about 1 atm.

It is possible to run the system at approximately constant pressure throughout by setting appropriate temperatures at each recovery stage as discussed above.

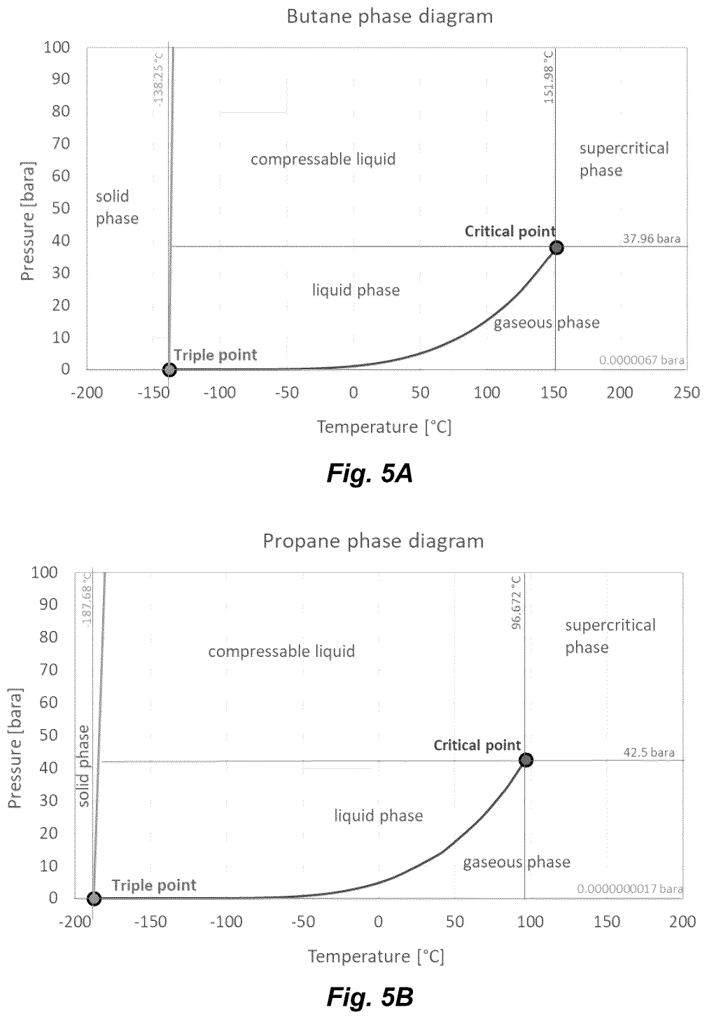

Conversely, it is possible to run the system at approximately constant temperature throughout by the use of compressors within or between one or more recovery stages. If the pressure of a stage is adjusted (increased) the gas will condense at a higher temperature. This relationship between pressure and temperature within the system can be understood with reference to phase diagrams. FIGS. 5A and 5B are phase diagrams for butane and propane respectively. In the case of a butane/propane mix that is commonly used in cannabis extraction, establishing a pressure of about 3.5 atm in the propane recovery stage would allow the heat exchanger in that stage to run at about 0C, or about the same as the boiling point of butane.

The use of different types of heat exchangers is also contemplated, in order to increase efficiency and/or reduce cost of the system. For example, a typical butane/propane mix in cannabis extraction is 70% butane and 30% propane. One configuration uses a tube and shell heat exchanger in the butane recovery stage and a tube in tube heat exchanger in the propane recovery stage. The tube and shell heat exchanger provides high surface area optimized for bulk recovery of the butane, while the tube in tube heat exchanger is a less expensive yet effective device for recovering the relatively smaller quantity of propane.

FIGS. 4A-4D are views of a heat exchanger used in an example embodiment. FIG. 4A is an isometric view of an example tube and shell heat exchanger 300. FIG. 4B is an isometric cross-sectional view of the heat exchanger 300, taken along cross section A shown in FIG. 4A. FIG. 4C is top plan cross sectional view of the heat exchanger 300, taken along cross section B shown in FIG. 4A. FIG. 4D is an elevational cross-sectional view of the heat exchanger 300, taken along cross section A shown in FIG. 4A.

In general, the described system advantageously reduces energy use and corresponding costs. In particular, the system uses a chilling temperature at each stage that closely matches the boiling point of the specific gas being condensed and recovered at that stage. An alternative approach to recover gases runs a single condenser (e.g., heat exchanger) at the lowest boiling point of the gases in the mixture. In the case of a mixture of n-butane (boiling point of 0C) and propane (boiling point of −40C), the condenser would have to run at or below −40C. This alternative approach is deficient compared to the described inventive system for at least two reasons. First, the alternative approach requires significantly more refrigeration resources than running a first heat exchanger at around −10C (to recover n-butane) and a second heat exchanger at around −50C (to recover propane). Second, the alternative approach recovers the gases in mixture, and thus does not have the ability to separate the gases.

While embodiments of the invention have been illustrated and described, as noted above, many changes can be made without departing from the spirit and scope of the invention. Accordingly, the scope of the invention is not limited by the above disclosure.

1-10. (canceled)

11. A system for separating a mixture of compressed gases, the system comprising:
an input port configured to receive the mixture of compressed gases, wherein the mixture of compressed gases includes gases S₁ . . . Sₙ (N>=1), each gas Sᵢ having a corresponding boiling point Tᵢ that is less than Tᵢ₋₁ and greater than Tᵢ₊₁; and
one or more recovery stages C₁ . . . Cₙ each having a heat exchanger, wherein each recovery stage Cᵢ is fluidly coupled to recovery stage Cᵢ₋₁ when i>1 or the input port when i=1, wherein each recovery stage Cᵢ is configured to:
receive from a mixture of gases Sᵢ . . . Sₙ from its corresponding prior stage;
recover gas Sᵢ in liquid form by operating the heat exchanger at a temperature T, such that Tᵢ>T>Tᵢ₊₁, thereby condensing gas Sᵢ into liquid form while allowing gas Sᵢ₊₁ . . . Sₙ to remain in gaseous form; and
provide a mixture of gases Sᵢ₊₁ . . . Sₙ to recovery stage Cᵢ₊₁.

12. The system of claim 11, wherein the temperature of the heat exchanger of each recovery stage Cᵢ is 10-20C below the corresponding Tᵢ.

13. The system of claim 11, wherein recovery stage C₁ recovers n-butane by establishing a temperature of −10 to −20C in its heat exchanger, and wherein recovery stage C₂ recovers propane by establishing a temperature of −50 to −60C in its heat exchanger.

14. The system of claim 11, wherein the heat exchanger of each recovery stage Cᵢ is a shell and tube heat exchanger.

15. The system of claim 11, wherein each recovery stage Cᵢ includes a jacketed column having an input port and an output port, wherein the jacketed column is configured to:
receive via the input port the gases Sᵢ . . . Sₙ from the corresponding prior recovery stage;
heat the gases Sᵢ . . . Sₙ thereby preventing reflux of the gases back to stage Cᵢ₋₁; and
provide via the output port of recovery stage Cᵢ the heated gases to the heat exchanger.

16. The system of claim 15, further comprising a compressor having an input port fluidly coupled to the output of the jacketed column of stage C₁ and an output port fluidly coupled to the input port of the heat exchanger stage C₁, such that pressure within the heat exchanger is higher than the pressure within the jacketed column, thereby raising the boiling point of gases S₁ . . . Sₙ.

17. The system of claim 15, further comprising a solute recovery stage comprising a heat exchanger including an input port, an output port, and a recovery port, wherein the heat exchanger is configured to:
receive via the input port of the solute recovery stage a solution comprising the mixture of compressed gases S₁ . . . Sₙ and a solute in liquid form;
apply heat to convert the mixture of compressed gases into gaseous form;
provide via the output port of the solute recovery stage the mixture of gases in gaseous form to the recovery stage C₁; and
provide the solute via the recovery port.

18. The system of claim 17, wherein the heat exchanger of the solute recovery stage is configured to:
receive liquid having a temperature greater than T₁;
transfer heat from the received liquid to the mixture of compressed gases; and
provide the liquid after heat transfer to the jacketed column of stage C₁ thereby heating compressed gas S₁ using waste heat from the solute recovery stage.

19. The system of claim 17, wherein the heat exchanger of stage C₁ is a tube and shell heat exchanger and the heat exchanger of stage C₂ is a tube in tube heat exchanger, wherein stage C₁ recovers butane and stage C₂ recovers propane.

20. The system of claim 11, further comprising a solute recovery stage comprising a heat exchanger configured to:
receive a solution comprising the mixture of compressed gases S₁ . . . Sₙ and a solute in liquid form;
apply heat to convert the mixture of compressed gases into gaseous form;
provide the mixture of gases in gaseous form to the recovery stage C₁; and
provide the solute via a recovery port.

21. The system of claim 11, wherein at least one of the recovery stages C₁ . . . Cₙ receives spent heating fluid from an upstream recovery stage.

22. The system of claim 21, wherein the upstream recovery stage is a solute recovery stage that is configured to:
receive a solution comprising the mixture of compressed gases Sᵢ . . . Sₙ and a solute in liquid form;
apply heat to convert the mixture of compressed gases into gaseous form;
provide the mixture of gases in gaseous form to the recovery stage C₁; and
provide the solute via a recovery port.

23. The system of claim 21, wherein the upstream recovery stage is one of the recovery stages C₁ . . . Cₙ₋₁.

24. The system of claim 11, wherein each recovery stage Cᵢ of the recovery stages C₁ . . . Cₙ includes a means for heating the mixture of gases Sᵢ . . . Sₙ received from its corresponding prior stage prior to its introduction into the heat exchanger of recovery stage Cᵢ, thereby preventing reflux of the gases back to stage Cᵢ₋₁.

25. The system of claim 24, wherein the means for heating the mixture of gases is a jacketed column.

26. The system of claim 11, wherein a first one of the recovery stages includes a tube and shell heat exchanger, and wherein a second one of the recovery stages includes a tube in tube heat exchanger.

27. The system of claim 11, wherein the system is isobaric, maintaining an internal pressure of about 1 atm.

28. The system of claim 11, wherein the system operates at substantially constant pressure throughout.

29. The system of claim 11, wherein the system includes a solute recovery stage configured to:
receive the solute recovery stage a solution comprising the mixture of compressed gases Sᵢ . . . Sₙ and a solute in liquid form; and
extract the solute from the mixture,
wherein the solution comprises a solute that includes one or more cannabinoids extracted from source plant material, wherein the gases include at least one of n-butane and propane.

30. The system of claim 11, wherein each recovery stage Cᵢ of the recovery stages C₁ . . . Cₙ includes a means for cooling the mixture of gases Sᵢ . . . Sₙ received from its corresponding prior stage, thereby condensing gas Si into liquid form while allowing gas Sᵢ₊₁ . . . Sₙ to remain in gaseous form.
